(19) United States
(12) Patent Application Publication
(10) Pub. No.: US 2017/0185805 A1
(43) Pub. Date: Jun. 29, 2017

(54) INTRUSION-PROTECTED MEMORY COMPONENT

(71) Applicant: Intelligent Technologies International, Inc., Miami Beach, FL (US)

(72) Inventors: David S Breed, Miami Beach, FL (US); Wendell C Johnson, San Pedro, CA (US)

(73) Assignee: Intelligent Technologies International, Inc., Miami Beach, FL (US)

(21) Appl. No.: 15/390,535

(22) Filed: Dec. 25, 2016

Related U.S. Application Data
(60) Provisional application No. 62/271,531, filed on Dec. 28, 2015.

(51) Int. Cl. G06F 21/78

(52) U.S. Cl. CPC G06F 21/78; G06F 2221/034

(57) ABSTRACT

Intrusion-protected component including a housing including a substrate containing a data storage component and access functionality only through which access to each data storage component is enabled, and conductors connected together in a single circuit to form a single transmission line. A processor renders each data storage component and/or access functionality inoperable upon detecting a variance in current or impedance caused by breaking of one of the conductors, e.g., causes the data storage component to self-destruct. The housing includes a head band worn on a person's head and an L-shaped housing part having a portion positioned in front of the frame. A display, imaging device, microphone and sound generator are arranged on or in the housing, and coupled to the processor which conducts a test while detecting cheating by monitoring images received by the imaging device and sounds received by the microphone.

### FIELD OF THE INVENTION

The present disclosure relates generally to the field of protecting biometric and other data on a memory component of a portable device to preclude use of the device in the event the device is stolen and the data is stolen and/or new biometric data is sought to be incorporated into the device to enable its use.

### BACKGROUND OF THE INVENTION

Smartphones are being used more and more for buying things using, for example, ApplePay™ and other systems. Smartphones are also getting more and more into biometrics, fingerprints, iris scans etc. A significant problem is that if someone loses their smartphone or it is stolen, the new possessor can substitute his/her biometrics for the original owner's biometrics and then clean them out of their money.

One solution to this problem is to store the biometric information on a remote site, but the thief can capture the owner's biometric data when it is sent to the remote site and then steal the device and input the captured data to spoof the system.

Other data may also need protection such as unique private keys of the owner which are stored on the device. If the device is stolen, then these private keys can also be stolen and used on other computing devices to allow access to information and assets which are intended only for the device owner. This permits the theft of cryptocurrency from digital wallets, for example.

### SUMMARY OF THE INVENTION

One embodiment of the invention provides a system and method to protect the biometrics or other confidential information stored on a portable device with a chassis intrusion detector (CID) such that if the device is stolen or otherwise possessed by an unauthorized user, the new possessor cannot access or remove the recorded data and/or substitute new data and thereby enable use of any monetary or other value associated with the device. A method for protecting biometric data in such a memory component is also envisioned and considered part of the invention.

### BRIEF DESCRIPTION OF THE DRAWINGS

The following drawings are illustrative of embodiments of the system developed or adapted using the teachings of at least one of the embodiments disclosed herein and are not meant to limit the scope of the disclosure as encompassed by the claims.

FIG. 1 is a drawing illustrating a memory component with a preferred chassis intrusion detector used in the invention.

FIG. 1A is a cross-sectional view taken along the line 1A-1A in FIG. 1.

FIG. 1B is an enlarged view of the section designated 1B-1B in FIG. 1A.

FIG. 2 is an illustration of the application of a chassis intrusion detector (CID) to protect a smartphone.

FIG. 3 is a schematic of the chassis intrusion detector electronics embedded within the memory component.

FIG. 4 is an example of a corresponding electronic circuit and its use applied to a smartcard using the chassis intrusion detector electronics shown in FIG. 3.

FIG. 5 is a flowchart explaining operation of the electronic circuit to the chassis intrusion detector electronics shown in FIG. 4.

FIGS. 6A and 6B are illustrations of a secure testing device from WO2016028864.

FIG. 7A-7E illustrate the application of the chassis intrusion detector to the device of FIGS. 6A and 6B, wherein FIG. 7A illustrates the housing, FIG. 7B illustrates the Chassis Intrusion Detector mesh, FIG. 7C is a partial cross section of the mesh taken along line 7C-7C in FIG. 7B, FIG. 7D illustrates the mesh wrapped or formed around the housing, and FIG. 7E illustrates the final assembly with the connector attached.

### DETAILED DESCRIPTION OF THE INVENTION

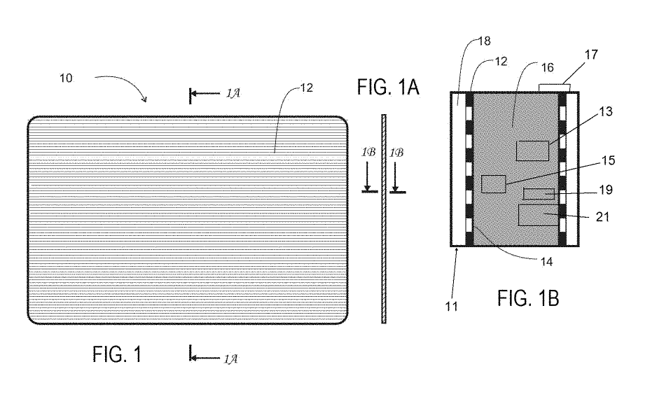

Referring to the accompanying drawings wherein like reference numbers refer to the same or similar elements, FIGS. 1, 1A and 1B illustrate a memory component 10 with a preferred chassis intrusion detector (CID) used in the invention. Memory component 10 typically comprises a housing 11 having an interior 13 including a substrate on which at least one data storage component 15, e.g., a RAM or ROM component only one of which is shown in FIG. 1B, is mounted and associated circuitry and electrical connects to enable access to the data storage component(s) 15. Housing 11 of the memory component 10 is covered with a series of parallel straight line conductors 12 which are spaced apart from each other, at least on the broad surfaces thereof, and not over an access portion 17 that enables access to the data storage component(s).

In another preferred implementation, wavy lines are used as conductors. Conductors 12, whether straight or wavy, may be spaced apart an equal distance from one another or at a variable spacing therebetween.

Conductors 12 are connected together to form a single completed transmission line where a current can pass to form a single complete circuit that totally engulfs the memory component 10. As shown in this implementation, conductors 12 are printed onto a thin film of plastic 14 which is bonded or otherwise attached to the outside of the memory component 10, e.g., the outer surface of housing 11 thereof, and protected with a protective plastic layer 18 that thus overlies conductors 12. The interior of the memory component 10 is represented at 16 in FIG. 1B. Although not illustrated, the conductors 12 wrap around the edges of the housing 11 of the memory component 10.

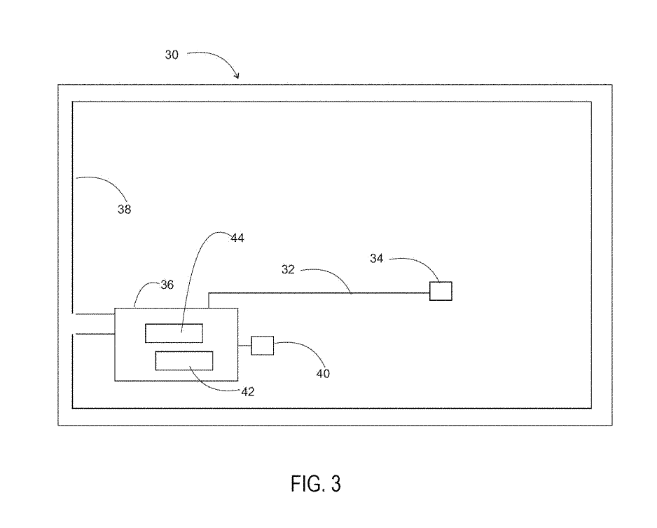

Power providing system 19 is arranged at least partly on housing 11 to provide power to operate the circuit (similar to the power providing system shown in FIG. 3 described below). Processor 21 is arranged on, in or within housing 11 of memory component 10 and considered a part thereof. Processor 21 may be configured to render data storage component 15 inoperable upon detecting a variance in current through or impedance of the transmission line defined by conductors 12 caused by breaking of one of the conductors 12. More specifically, processor 21 may be configured to render data storage component 15 inoperable by, for example, causing data storage component 15 to self-destruct. It can also cause the only manner of accessing data storage component 15 to be destroyed, i.e., the coupling (e.g., USB) to data storage component 15, thereby prevent any access to data storage component 15.

Memory component 10 contains biometric or other data entered via a separate biometric data sensor, or other input device, that is configured to receive input from or related to a person authorized to use the device into which memory component 10 is inserted. For example, memory component 10 may be inserted into a smartphone having a fingerprint sensor or iris scanner (not shown) and the owner of the smartphone interacts with the fingerprint sensor or iris scanner to provide their biometric data which is provided to and stored in memory component 10.

In the illustration, the conductive lines are shown to be straight and opaque. In one preferred application, the lines are made wavy and sufficiently thin that they are transparent. The wires can be printed from a variety of conductive materials such as aluminum, copper, indium tin oxide, and carbon-based materials such as graphene. These wires are connected so as to form a continuous circuit that totally surrounds the memory component 10. If any of these wires is broken or the circuit is modified such as by shorting some of the wires, such that the circuit no longer conducts electricity or the circuit impedance is changed, then this fact is sensed by the CID circuitry (including a microprocessor) which causes memory component 10 to erase its contents and/or otherwise self-destruct. The manner for which a memory component 10 can self-destruct may be any known self-destruction method known to those skilled in this field. An example is the removal of power from a volatile memory such as RAM.

As an alternative to the wires used in FIG. 1, two layers of conductive material separated by a thin film can create a capacitor which also could be used to detect a breach in the surface of memory component 10. These conductive films can be made of indium tin oxide and be transparent. Since a carefully placed hole or multiple holes through the plastic film assembly can cause only a minor change in the capacitance, a preferred alternative construction, as illustrated in FIG. 1, is to replace the two conductive layers and separating plastic film with a single layer comprising a labyrinth of wires which are very narrow and closely spaced such that any attempt to penetrate the film will cause one or more of these wires to be cut. The microprocessor therefore monitors the total resistance, inductance or mutual inductance of this circuit and causes memory component 10 to self-destruct if there is a significant change in these measurements. Even the shorting of a subset of these wires accompanying an attempt to open an access hole without breaking the circuit is detectable by the monitoring circuit. It can also cause the only manner of accessing the memory component 10 to be destroyed thereby prevent any access to the memory component 10.

Since any attempt to break into memory component 10 will necessarily sever one of these wires or change the circuit impedance, this design provides an easily detectable method of determining an attempt to intrude into memory component 10.

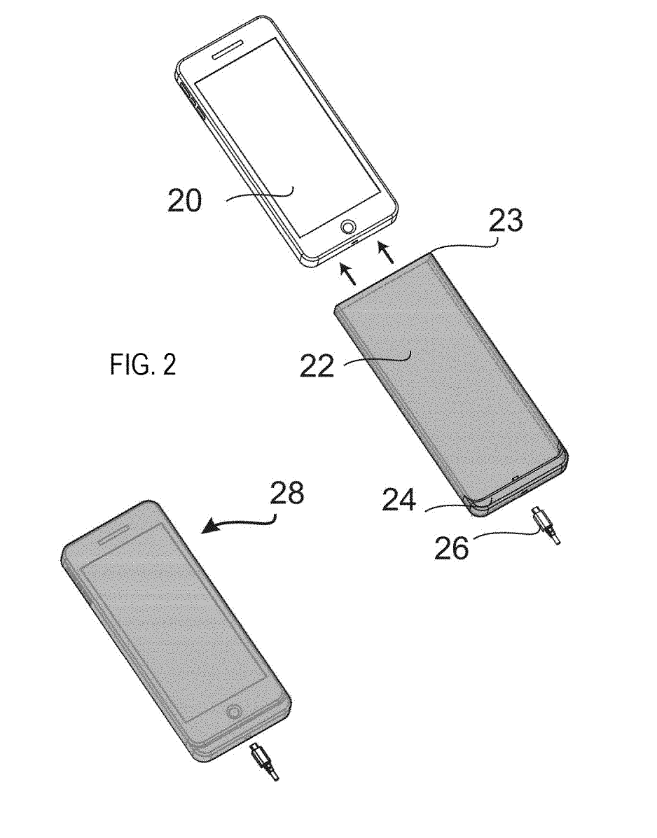

A representative application of the use of a CID of this invention is to protect a smartphone as shown in FIG. 2. A smartphone 20 is covered by a CID 22 containing appropriate circuitry including a microprocessor as the processor, conductors, battery as the power providing system (as described above) and memory component 24 (similar to RAM memory 42 described below). Prior to installation with smartphone 20, CID device 22 is made as one piece including an open end 23 and has a shape to fit snugly over the smartphone 20. The smartphone 20 is inserted into the open end 23.

Then, the open end 23 of the CID device 22 is folded over during assembly and cemented in place yielding the final assembly 28. CID device 22 covers the entire smartphone except for the access port for connector 26 which is not covered by CID device 22. CID device 22 does not have any part that penetrates into the smartphone 20, but rather only overlies it. CID device 22 is a self-contained unit in which memory component 24 contains the data relating to value of the smartphone 20. When the conductors of the CID 22 are disturbed, the processor of the CID 22 causes the memory component 24 to erase its data and/or self-destruct. It can also cause the only manner of accessing the memory component 24 to be destroyed thereby prevent any access to memory component 24. Access to the data on memory component 24 is via usual techniques involving smartphone, e.g., NFC, as well as the providing of the data to the memory component 24 which is to be secured.

A schematic of another example of a chassis intrusion detector system for use with a smartcard is shown in FIG. 3 generally at 30. Power to operate the circuit can be supplied from a rechargeable battery or an external device such as the NFC (power providing system) through a wire 32 to an antenna 34 which couples to the NFC reader, not shown. Wire 32 also provides communication from the electronics and sensors assembly of which the security assembly (SA) 36 is a part. The fine wire maze is shown schematically at 38, the SA at 36, a long-life battery at 40 and a RAM volatile memory at 42. Long-life battery 40 is present to provide sufficient power to operate he SA 36 for the life of the memory component 10, typically 5-10 years.

SA 36 can be a separate subassembly which is further protected by being potted with a material such that any attempt to obtain access to the wires connecting battery 40 to a microprocessor 44 therein or to RAM memory 42 would be broken during such an attempt. This is a secondary precaution since penetration to SA 36 should not be possible without breaking wire maze 38 and thus causing self-destruction of RAM memory 42. The power can be removed by microprocessor 44. It can also cause the only manner of accessing the RAM memory 42 to be destroyed thereby prevent any access to the RAM memory 42.

To summarize, any disruption of the mesh or conductive film in either of the above described examples will cause self-destruction of the contents of the memory component 10 with a chassis intrusion detector (CID) microprocessor making it impossible to decode the data sent from the smartcard issuer who will therefore deny transaction approval. After the assembly is completed, the microprocessor 44 can be powered on and the first step will be to measure the inductance, resistance, and capacitance, as appropriate, of the mesh or films. If any of these measurements significantly change, the circuit in SA 36 would remove power from RAM memory 42 thereby causing self-destruction of the contents of the RAM memory 42. Once the data has self-destructed, any value residing in the smartphone or smartcard or similar device in which the memory component 10 is situated, would not be usable. A thief could thus not use the smartphone, for example, to purchase items or to spend resident bitcoins. In the bitcoin case the bitcoin codes would need to be also stored elsewhere to prevent their irretrievable loss.

When the SA 36 is loaded with the biometric or other data during manufacture or thereafter, it can be done so through two fused links, not shown, which can be broken after the loading process has occurred and been verified. Thereafter, the biometric or other data in the memory component 10 cannot be changed or reloaded.

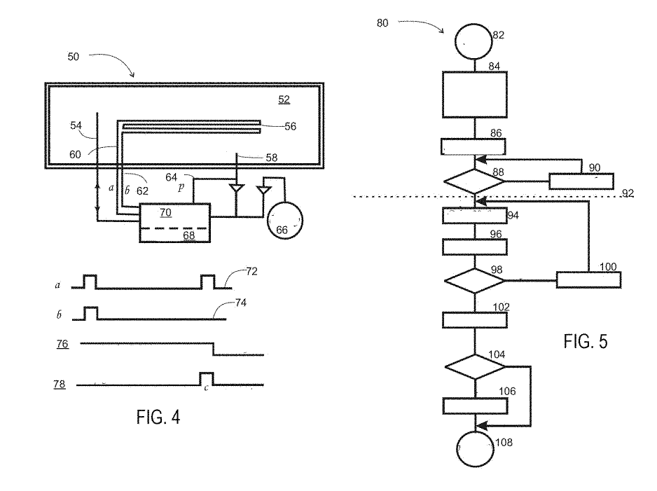

FIG. 4 illustrates the circuit of the memory component containing the SA generally at 50. The memory component is illustrated at 52 and the SA microcomputer and RAM, for the volatile memory implementation, at 70 and 68, respectively. The long-life battery that powers the SA for several years is illustrated at 66. 64 is a signal that indicates that power is available for the memory component 52. This power can be supplied by a rechargeable battery located on the memory component 52 or by the NFC reader through an antenna, not shown, on the memory component 52. The system is designed such that if power is available from the memory component 52, its voltage will be higher than that from the battery 66 and therefore the total power needed to supply the microprocessor 70 will come from the external source.

In this manner, battery 66 has its life extended. Bidirectional serial communication takes place through wire 54. A testing pulse is imposed on the mesh 66 through wire 60 labeled a. The returned signal comes through wire 62 labeled b. The pulse at a is shown at 72 and consists of a 20 μs burst which is repeated every second, or at some other convenient value. The signal indicated by the trace 74 illustrates the integrity of the mesh at the beginning where it responds with an attenuated 20 μs pulse. However, after the one second when the second pulse arrived and was not sensed by the microprocessor 70, b did not register a corresponding pulse indicating that the wire mesh had been severed.

Signal 76 indicates that the private key (PK) is present in the RAM (PK in RAM) and, due to the failure of the mesh at the second burst pulse, the RAM was cleared (RAM Clear). Trace 78 indicates that a message was sent to the memory component 52 indicating that intrusion had taken place.

A flowchart of this process is shown generally at 80 in FIG. 5. The process starts at step 82 and at step 84, the microprocessor in the SA is programmed and the data is loaded into RAM. If the memory component is designed so that the data can only be loaded once, then the fuses are also blown at step 84. The power available indicator P is then set to zero indicating that the rechargeable battery has not been charged nor is the memory component receiving energy from another external source such as the near field reader. Note that the same antenna which harvests power from the near field reader can be used to receive power from any available charging source.

At step 86, the SA microprocessor is started, however the every one second pulses will not be initiated. This is to conserve power of the SA battery. Sensing of power from the memory component, indicated here as P equals one, is used to indicate the once per second pulses have started. This is indicated by the dashed line 92.

At step 94, the 20 μs pulse is driven onto conductor a and conductor b is tested for presence of the signal at step 96. If conductor b received the pulse indicating that integrity of the wire mesh is intact, the decision is made at step 98 to transfer control to step 100 where the one second delay occurs after which control is transferred back to step 94. If no signal was sensed on b, then step 98 transfers control to step 102 where the biometric data, private key and any other information, is erased from RAM. Control is then transferred to step 104 where a check is made as to whether power is available from the memory component and if so a message “intrusion” is sent to the memory component at 106. In either case, the process terminates at step 108 where the microprocessor is turned off.

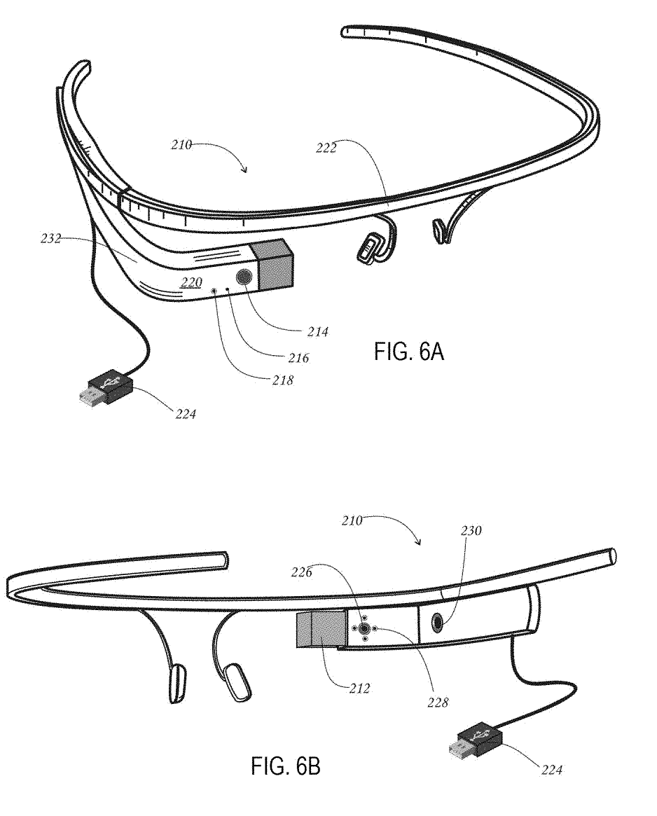

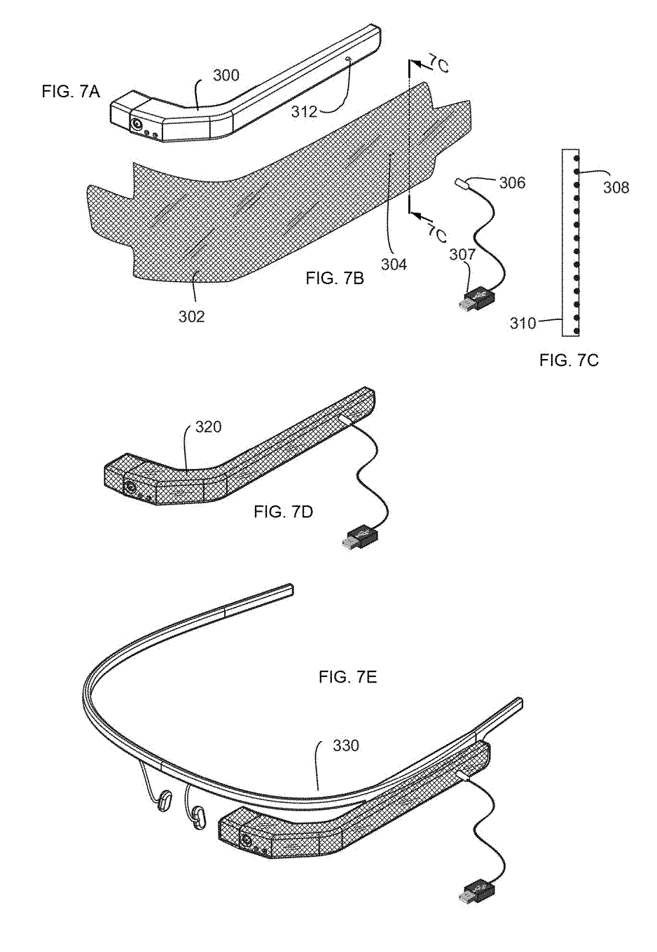

An example of the application of the CID for use with a testing device as disclosed in WO2016028864 and illustrated in FIGS. 6A and 6B, is illustrated in FIGS. 7A-7E.

A device constructed in accordance with the teachings of the invention of WO2016028864 is illustrated in FIG. 6A which is a perspective view of a head worn glasses type device, the Test Glasses, containing an electronics assembly with several sensors, cameras and a display all protected with a chassis intrusion detector prepared using the teachings herein. A head worn display and electronics device constructed in accordance with the invention is shown generally at 210 in FIGS. 6A and 6B.

Housing 220 extends from a frame 222, which has head band shape. Housing 220 is substantially L-shaped with a first portion extending straight outward from an edge of the frame 222 and second portion approximately perpendicular to the first portion and positioned in front of the frame 222.

A display 212 is arranged on or in the housing 220 and pointed toward the right eye of the wearer, e.g., a test-taker, and displays test questions (although alternatively, a display can be pointed toward the left eye of the test-taker). A forward viewing camera 214, representative of one or more imaging devices, is also arranged on or in the housing 220 and monitors the field of view of the wearer outward from the device 210. Camera 214 can have a field of view of approximately 120°. A microphone 216, representative of one or more sound detectors, is also arranged on or in housing 220 and monitors talking (sounds) which can take place while the test is in progress, e.g., while test questions are displayed on display 212. A sound maker or speaker 218, representative of one or more sound generators, is arranged on or in the housing 220 and periodically provides a sound detectable by the microphone 216 so as to verify that the microphone 216 has not somehow been rendered inoperable.

Display 212 is arranged at a terminal end of the second housing portion. The forward viewing camera 214, or more generally at least one imaging device, the microphone 216 and the speaker 218 are also arranged on or in the second housing portion (see FIG. 6A).

Each of these components 212, 214, 216, 218 is connected to a processor-containing electronics package in housing 220 which is mounted to the glasses frame 222 in a manner known to those skilled in the art to which this invention pertains. A cable emanates from the electronics package in housing 220 and can contain a USB connector 224 for connecting onto an external device such as a computer.

An iris or retinal scan camera 226 is arranged on housing 220, pointing inward toward the wearer, and measures biometrics of the test-taker (see FIG. 6B). Such biometrics can include an iris or retinal scan or a scan of the portion of the face surrounding the eye. Illumination of the eye can be provided by one or more LEDs 228 arranged on the housing 220 which can be in the IR or visible portions of the electromagnetic spectrum. Two or more different levels of visible illumination can be provided to cause the iris to be seen at different openings to check for an artificial iris painted onto a contact lens. The iris scan camera 226 and LEDs 228 are arranged on the second housing portion (see FIG. 6B).

Other aspects of the Test Device are disclosed in WO2016028864 which is included herein by reference.

The entire electronics package of the device 210 is encapsulated in a thin film 232 called a chassis intrusion detection film (similar to or the same as disclosed above). Specifically, this film can comprise an array of wires which can be printed onto a plastic film either before or after it has encapsulated the electronics package in housing 220 in such a manner that any attempt to break into the housing 220 will sever or otherwise disrupt one or more of the wires. The wires can be made from indium tin oxide and thus be transparent. The wires can be thin, such as about 0.001 inches wide, and have a similar spacing. In some cases, the wires can be made as small as 1 micron (40 microinches) and can be made of materials such as graphene, copper, silver or gold and still be transparent. Transparency is desirable since the film can extend over the camera lenses and the display.

The housing prior to attachment of the CID is illustrated at 300 in FIG. 7A. Pins for connecting the electronics inside the housing 300 to the connector 306 are illustrated at 312. Although not shown, additional short pins for connecting the CID circuitry to the mesh 302 can be in the form of short sleeves around the pins 312. The wire mesh making up the CID is illustrated in FIG. 7B generally at 302. Holes 304 are provided in the mesh 302 to allow two or more pins 312 (shown as two in this illustration) to pass through the mesh 302 without contacting the mesh wires (an access functionality). Although not illustrated, since the holes register the mesh 302 to the housing 300, terminating ends of the mesh 302 can attach to corresponding circumferential pins on the housing 300 used for providing power and monitoring the impedance of the mesh 302 by the processor-containing electronics package in housing 300. This can be facilitated if the holes in the mesh 302 are made conductive with one attaching to each end on the wire transmission line in which case the pins coming though the holes would be insulated from the conductive holes. Many other methods for accomplishing the functions of connecting the interior CID circuit (including a processor) to the mesh 302 and for allowing pins to pass thought the mesh 302 to facilitate the connector 306 connection to the housing 300 will now be obvious to one skilled in the art.

FIG. 7B also illustrates the connector 306 for connecting to the electronic circuit within the housing and the USB connector 307 for connecting to an external computer or other device. Other connector types can of course be used.

FIG. 7C illustrates a portion of a cross section of the CID mesh and is comprised of conductor wires 308 and film 310. The wires 308 (not shown to scale) can be printed onto the film 310 or attached by some other convenient method. The film 310 can be made from plastic material such as polyamide coated with a cyanoacrylate UV curable or a thermal setting adhesive which is in the uncured state prior to wrapping or forming around the housing 300. The film 310 can be about 0.003 thick for the polyamide and about 0.002 thick for adhesive for a total thickness of about 0.005 which can be increased up to about 0.01 inches thick, if the application warrants, such that when cured it forms a strong substance to hold the wires and permit wear and substantial abuse to the assembled housing package without damaging the wires. The wires are near one side of the mesh assembly and that side is assembled against the housing 300 allowing for the main film thickness to be on the outside.

FIG. 7D illustrates the housing 300 after it has been covered by the CID mesh 320 and with the connector and wire assemble attached. After the mesh 302 has been wrapped or formed around the housing 300, it is preferably exposed to UV radiation which cures the adhesive forming a continuous covering of the housing 300. Any attempt thereafter to obtain access to protected data within the housing 300 by a physical entry into the housing 300 will sever one or more wires of the mesh 302 resulting in the destruction of the data as described above.

FIG. 7E illustrates the final assembly onto a supporting head band frame 330. This assembly permits the full functioning of the cameras, display, microphone, speaker etc. that must operate through the CID while simultaneously protecting the data housed inside the device from unwanted exposure.

In embodiments described above, there is a memory in the CID, or more generally a data storage component, which houses the private key or biometric information. For example, the memory may be housed in the housing 300 (or memory 24 or 42). The data storage component can be RAM which needs power or it loses its memory contents. It is called “volatile” memory for that reason. Thus, when power is no longer supplied to the RAM as a result of detection of intrusion into the housing 300, the RAM loses its memory contents (to thereby achieve objectives of the invention). The invention is not restricted to having the biometric memory in the CID memory, but it is one possible location.

Finally, all patents, patent application publications and non-patent material identified above are incorporated by reference herein. The features disclosed in this material may be used in the invention to the extent possible.

1. An intrusion-protected memory-containing assembly, comprising:
a housing including a substrate containing at least one data storage component and an access functionality only through which access to said at least one data storage component is enabled, said housing including a head band frame adapted to be worn on a head of a person and a generally L-shaped housing part, said L-shaped housing part having a first portion extending from said frame substantially straight outward from an edge of said frame and a second portion approximately perpendicular to said first portion and positioned in front of said frame;
a display arranged on or in said housing and oriented toward a rear of said frame;
at least one imaging device arranged on or in said housing and having a field of view outward from said frame;
at least one microphone arranged on or in said housing;
at least one sound generator arranged on or in said housing;
conductors arranged on said housing and connected together in a single circuit to form a single transmission line, whereby breaking of one of said conductors causes variation of current through or impedance of the transmission line, said conductors covering said housing except for said access functionality; and
a processor configured to render at least one of said at least one data storage component and said access functionality inoperable upon detecting a variance in current through or impedance of the transmission line defined by said conductors caused by breaking of one of said conductors and thereby prevent access to data in said at least one data storage component.

2. The assembly of claim 1, further comprising a film of plastic on which said conductors are formed, said plastic film being situated on an outer surface of said housing, and a protective plastic layer arranged on said plastic film over said conductors.

3. The assembly of claim 1, wherein said processor is configured to render said at least one data storage component inoperable upon detecting a variance in current through the transmission line defined by said conductors caused by breaking of one of said conductors by causing said at least one data storage component to self-destruct.

4. The assembly of claim 1, further comprising a power providing system arranged at least partly on said housing to provide power to operate said circuit.

5. The assembly of claim 1, wherein said housing is configured to house a smartphone and includes an opening where said conductors are not present that aligns with an opening of said smartphone.

6. The assembly of claim 1, wherein said at least one data storage component comprises a private key or biometric information.

7. The assembly of claim 1, wherein said conductors cover said display, said at least one imaging device, said at least one microphone and said at least one sound generator.

8. The assembly of claim 1, wherein said display, said at least one imaging device, said at least one microphone and said at least one sound generator are coupled to said processor.

9. The assembly of claim 8, wherein said processor is configured to conduct a test of a class using said display, said at least one imaging device, said at least one microphone and said at least one sound generator while detecting cheating on the test by monitoring images received by said at least one imaging device and sounds received by said at least one microphone.

10. The assembly of claim 1, further comprising at least one pin on said housing which constitutes said access functionality, a cable with a USB connector attaching to said at least one pin.
